(19) United States
(12) Patent Application Publication
(10) Pub. No.: US 2016/0057737 A1
(43) Pub. Date: Feb. 25, 2016

(54) APPARATUS FOR TRANSMITTING CONTROL INFORMATION AND APPARATUS FOR RECEIVING CONTROL INFORMATION

(71) Applicant: INTELLECTUAL DISCOVERY CO., LTD., Seoul (KR)

(72) Inventor: Sun Woo KIM, Seoul (KR)

(73) Assignee: INTELLECTUAL DISCOVERY CO., LTD., Seoul (KR)

(21) Appl. No.: 14/779,426

(22) PCT Filed: Mar. 26, 2014
(86) PCT No.: PCT/KR2014/002565

§ 371 Date: Sep. 23, 2015

(30) Foreign Application Priority Data
Mar. 27, 2013 (KR) 10-2013-0032710
Mar. 27, 2013 (KR) 10-2013-0032724
Apr. 30, 2013 (KR) 10-2013-0048728
Apr. 30, 2013 (KR) 10-2013-0048822

(51) Int. Cl. H04W 72/04

(52) U.S. Cl. CPC H04W 72/042; H04W 72/0446; H04W 88/08

(57) ABSTRACT

The present invention relates to a method and apparatus for scheduling downlink or uplink transmission in a plurality of subframes through one control channel in order to reduce control channel overhead.

### TECHNICAL FIELD

The present invention relates to an apparatus for transmitting/receiving control information in a wireless communication system.

### BACKGROUND ART

According to advances of communication systems, users such as individuals and companies are using various types of wireless terminals. Current mobile communication systems such as Long Term Evolution (LTE) and LTE-Advanced of 3GPP are high-speed and large-capacity communication systems capable of transmitting and receiving a variety of data such as video, wireless data, etc. as well as voice, and developments of technologies which can transmit a large amount of data equal to those of wired communication networks.

In such the system, time-frequency resources may be divided into a region through which a control channel (e.g., Physical Downlink Control Channel (PDCCH)) is transmitted, and a region through which a data channel (e.g., a Physical Downlink Shared Channel (PDSCH)) is transmitted.

Data may be transmitted in time-frequency resource through a data region, excluding a control region. In order to transmit a large amount of data, it is required to extend the size of the data region, and for this, a method of reducing the size of the control region may be demanded for effectively transmitting control information.

### DISCLOSURE

### Technical Problem

The present invention is to provide an apparatus for reducing size of control region by effectively transmitting control information, and thereby extending size of data region.

### Technical Solution

In accordance with an example embodiment of the present invention, a base station may comprise a control part generating downlink control information (DCI) for one or more subframes; and a transmitting part transmitting the downlink control information through a downlink control channel.

In accordance with another example embodiment of the present invention, a terminal may comprise a receiving part receiving downlink control information (DCI) through a downlink control channel; and a control part extracting control information of a downlink data channel positioned in one or more subframes or control information of a uplink data channel positioned in one or more subframes from the downlink control information.

In accordance with still another example embodiment of the present invention, a base station comprise a control part generating downlink control information (DCI); and a transmitting part transmitting the downlink control information through a downlink control channel, wherein the downlink control information includes a field indicating a subframe including a data channel to which the downlink control information is applied.

In accordance with still another example embodiment of the present invention, a terminal may comprise a receiving part receiving downlink control information (DCI) including a field indicating a subframe through a downlink control channel; and a control part controlling a data channel of a subframe indicated by the field based on the downlink control information.

### Advantageous Effects

According to the above-described present invention, the size of control region can be reduced by effectively transmitting control information so that the size of data region can be extended.

### DESCRIPTION OF DRAWINGS

FIG. 1 illustrates a communication system to which example embodiments of the present invention are applied.

FIG. 2 is a conceptual diagram of small cell scenarios.

FIG. 3 illustrates one of small cell scenarios of FIG. 2.

FIG. 4 and FIG. 5 illustrate another one of small cell scenarios of FIG. 2.

FIG. 6 illustrates still another one of small cell scenarios of FIG. 2.

FIG. 7 is a diagram to explain a concept of scheduling through PDCCH.

FIG. 8 is a diagram to explain a concept of multi-subframe scheduling through PDCCH according to an example embodiment of the present invention.

FIG. 9 is a diagram to explain a concept of multi-subframe scheduling through EPDCCH according to another example embodiment of the present invention.

FIG. 10 is a diagram to explain a concept of cross-carrier/multi-subframe scheduling according to still another example embodiment of the present invention.

FIG. 11 is a flowchart illustrating a method of transmitting/receiving control information according to an example embodiment of the present invention.

FIG. 12 and FIG. 13 are diagrams to explain a cross-subframe scheduling through PDCCH according to still another example embodiment of the present invention.

FIG. 14 and FIG. 15 are diagrams to explain a cross-subframe scheduling through PDCCH according to still another example embodiment of the present invention.

FIG. 16 and FIG. 17 are diagrams to explain a cross-carrier/cross-subframe scheduling concept according to still another example embodiment of the present invention.

FIG. 18 is a block diagram showing a configuration of a base station according to an example embodiment of the present invention.

FIG. 19 is a block diagram showing a configuration of user equipment according to an example embodiment of the present invention.

### BEST MODE

Hereinafter, exemplary embodiments of the present invention will be described with reference to the accompanying drawings. In the following description, the same elements will be designated by the same reference numerals although they are shown in different drawings. Furthermore, in the following description of the present embodiment, a detailed description of known functions and configurations incorporated here will be omitted when it may make the subject matter of the present embodiment unclear.

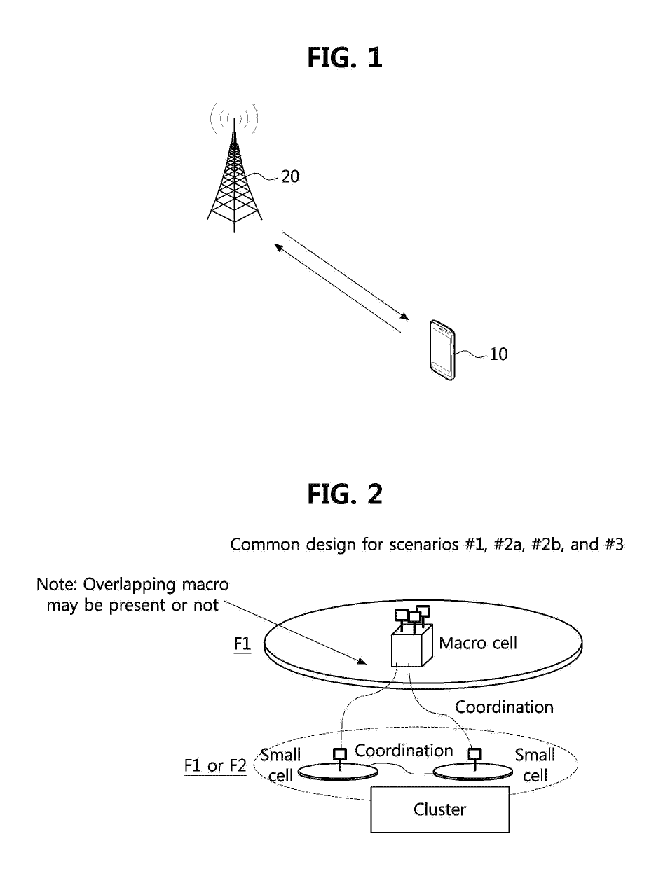

FIG. 1 illustrates a communication system to which example embodiments of the present invention are applied.

The communication system may be deployed widely in order to provide a variety of communication services such as a voice service, a packet data service, and so forth.

Referring to FIG. 1, the communication system may include user equipment (UE) 10 and a transmission point 20 which performs uplink and downlink transmissions with the UE 10.

The terminal or UE 10 in the present specification may be understood as a general concept that includes a mobile station (MS), a user terminal (UT), a subscriber station (SS), and/or a wireless device in a global system for mobile communications (GSM), as well as user equipment used in wideband code division multiple access (WCDMA), long term evolution (LTE), and/or high speed packet access (HSPA).

In the present description, the transmission point 20 or the cell may be construed as an inclusive concept indicating a porting of an area or a function covered by a base station controller (BSC) in code division multiple access (CDMA), a Node-B in WCDMA, an eNB or a sector (a site) in LTE, and the like. Accordingly, a concept of the transmission point may include a variety of coverage areas such as a megacell, a macrocell, a microcell, a picocell, a femtocell, and the like. Furthermore, such concept may include a communication range of the relay node (RN), the remote radio head (RRH), or the radio unit (RU).

In the present description, the user equipment 10 and the transmission point 20 may be transmission/reception subjects, having an inclusive meaning, which are used to employ the technology and the technical concept disclosed herein, and may not be limited to a specific term or word.

Although only one terminal 10 and only one transmission point 20 are illustrated in FIG. 1, the present invention is not limited to such the environment. That is, it is possible that a single transmission point 20 communicates with multiple terminals 10 and vice versa.

The communication system may use a variety of multiple access schemes such as CDMA, time division multiple access (TDMA), frequency division multiple access (FDMA), orthogonal frequency division multiple access (OFDMA), OFDM-FDMA, OFDM-TDMA, OFDM-CDMA, and/or the like.

Also, in the case of an uplink transmission and a downlink transmission, the present invention may use a time division duplex (TDD) performing the uplink/downlink transmissions using different times, a frequency division duplex (FDD) performing the uplink/downlink transmissions using different frequencies, or a hybrid duplexing combining the TDD and the FDD.

Specifically, example embodiments of the present invention may be applied to in the field of asynchronous wireless communications evolving to Long Term Evolution (LTE) and LTE-Advanced (LTE-A) through GSM, WCDMA, and HSPA, and in the field of synchronous wireless communications evolving to CDMA, CDMA-2000, and UMB. The present invention should not be construed as being limited to or restricted by a particular communication field, and should be construed as including all technical fields to which the spirit of the present embodiment can be applied.

Referring to FIG. 1, the terminal 10 and the transmission point 20 may perform uplink and downlink communications with each other.

The transmission point 20 may perform downlink transmission to the terminal 10. The transmission point 20 may transmit a physical downlink shared channel (PDSCH), a main physical channel for unicast transmission. Also, the transmission point 20 may transmit control channels such as a physical downlink control channel (PDCCH) for transmission of downlink control information for receiving PDSCH and scheduling grant information for transmitting uplink data channel (e.g., physical uplink shared channel (PUSCH)), a physical control format indicator channel (PCFICH) for transmitting an indicator separating regions of PDSCH and PDCCH, a physical HARQ indicator channel (PHICH) for transmitting acknowledgement of hybrid automatic repeat request (HARQ), etc. Hereinafter, transmission of signals through respective channels is described as transmission of respective channels.

FIG. 2 is a conceptual diagram of small cell scenarios.

A small cell may be within coverage of a macro cell or out of coverage of the macro cell. Meanwhile, a small cell may use a common channel with the macro cell (co-channel deployment case), or its frequency may be separated from that of the macro cell.

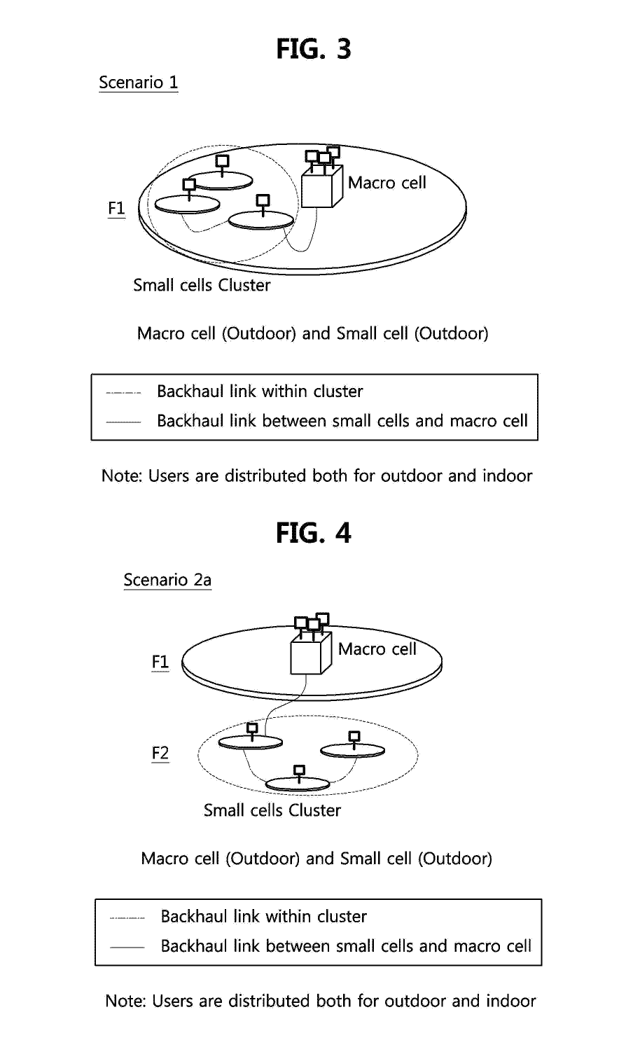

FIG. 3 illustrates one of small cell scenarios of FIG. 2.

Referring to FIG. 3, the macro cell and the small cell may use a common channel. Here, a cluster of small cells may be considered. In the small cell cluster, more small cells may exist as a dense environment than those of R10 eICIC, R11 ReICIC/CoMP environments. The number of small cells in each small cell cluster, backhaul assumption between small cells, and temporal synchronization between small cells may be specified. The small cell scenario illustrated in FIG. 3 may be an out-door type scenario. Meanwhile, a non-ideal backhaul may be configured between the macro cell and the small cell. In this case, macro coverage may exist.

Coordination between macro cell and small cells may be performed or not.

Ideal-backhaul and non-ideal backhaul may be configured between small cells in a small cell cluster, or between at least one macro cell (eNB) and the small cell cluster. Non-ideal backhaul may be considered for other interfaces. The non-ideal backhaul means a backhaul that is not a fiber used for implementing a RRH (CPRI).

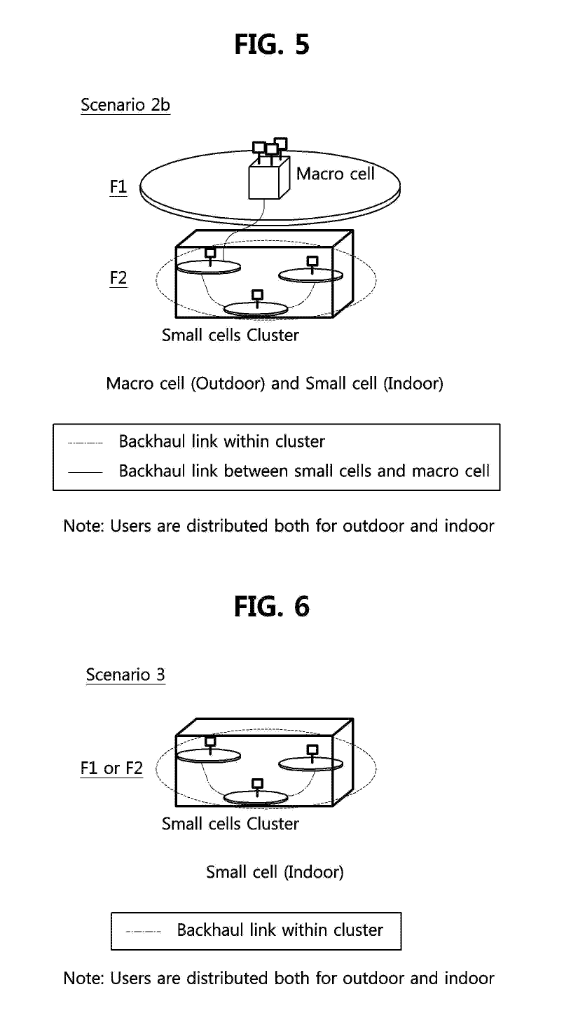

FIG. 4 and FIG. 5 illustrate another one of small cell scenarios of FIG. 2.

Referring to FIG. 4 and FIG. 5, separated frequencies can be used for macro cell and small cell. In this case, a cluster of small cells may be considered. In the small cell cluster, more small cells may exist as a dense environment than those of R10 eICIC, R11 ReICIC/CoMP environments. The number of small cells in each small cell cluster, backhaul assumption between small cells, and temporal synchronization between small cells may be specified. The small cell scenario illustrated in FIG. 4 may be an out-door type scenario, and the small cell scenario illustrated in FIG. 5 may be an indoor scenario.

Meanwhile, a non-ideal backhaul may be configured between the macro cell and the small cell. In this case, macro coverage may exist. Coordination between macro cell and small cells may be performed or not.

As described above, in the small cell scenario illustrated in FIG. 4 and FIG. 5, ideal-backhaul and non-ideal backhaul may also be configured between small cells in a small cell cluster, or between at least one macro cell (eNB) and the small cell cluster. Non-ideal backhaul may be considered for other interfaces.

FIG. 6 illustrates still another one of small cell scenarios of FIG. 2.

Referring to FIG. 6, there is not macro coverage in this small cell scenario. In this case, a cluster of small cells may be considered. In the small cell cluster, more small cells may exist as a dense environment than those of R10 eICIC, R11 ReICIC/CoMP environments. The number of small cells in each small cell cluster, backhaul assumption between small cells, and temporal synchronization between small cells may be specified. The small cell scenario illustrated in FIG. 6 may be an indoor scenario. Both sparse and dense small cells may be considered.

Meanwhile, scheduling on a downlink data channel (e.g., PDSCH) or an uplink data channel (e.g., PUSCH) may be performed by using PDCCH or EPDCCH.

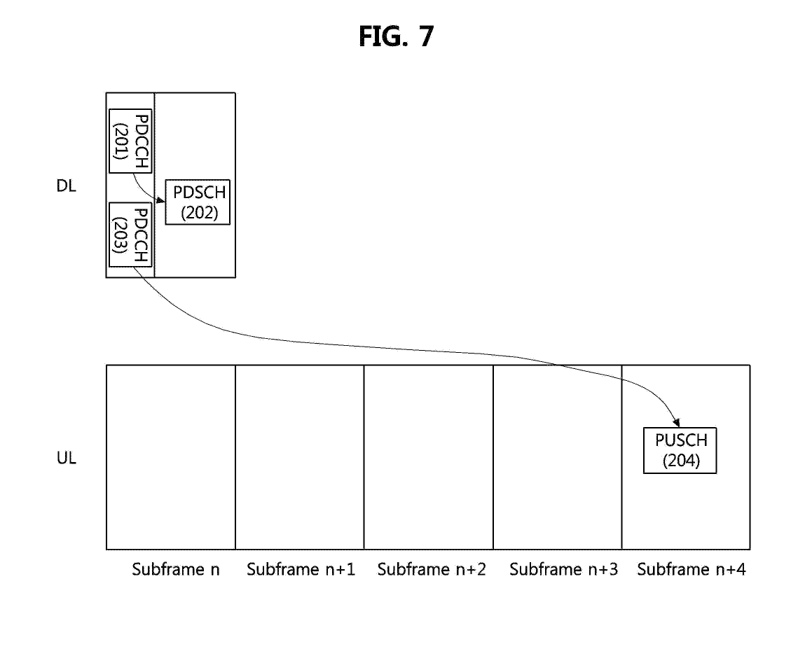

FIG. 7 is a diagram to explain a concept of scheduling through PDCCH.

Referring to FIG. 7, PDCCH 201 may be used for transmitting downlink control information such as scheduling information needed for reception of a downlink data channel, PDSCH 202. PDCCH 201 may be used for transmitting downlink control information for PDSCH 202 located in the same subframe with the PDCCH.

Also, PDCCH 203 may be used for transmitting scheduling grant information needed for transmission of a downlink data channel, PUSCH 204. In case of FDD, scheduling grant information needed for transmitting PUSCH 204 of a subframe (n+4) is transmitted in PDCCH 203 of a subframe n. In case of TDD, scheduling grant information needed for transmitting PUSCH 204 of a subframe (n+k) is transmitted in PDCCH 203 of a subframe n, and a value of k may be determined according to a TDD configuration and the subframe number n.

Although PDCCH located within the control region is illustrated in FIG. 7, EPDDCH located within the data region may also be used for transferring downlink control information or uplink scheduling grant information in a similar manner.

On the other hand, in order to reduce overhead of control channels, it may be considered to transfer control information for a plurality of subframes by using a single control channel (PDCCH or EPDCCH). In the present description, this way is referred to as ‘multi-subframe scheduling’. However, the present invention is not restricted by such the naming.

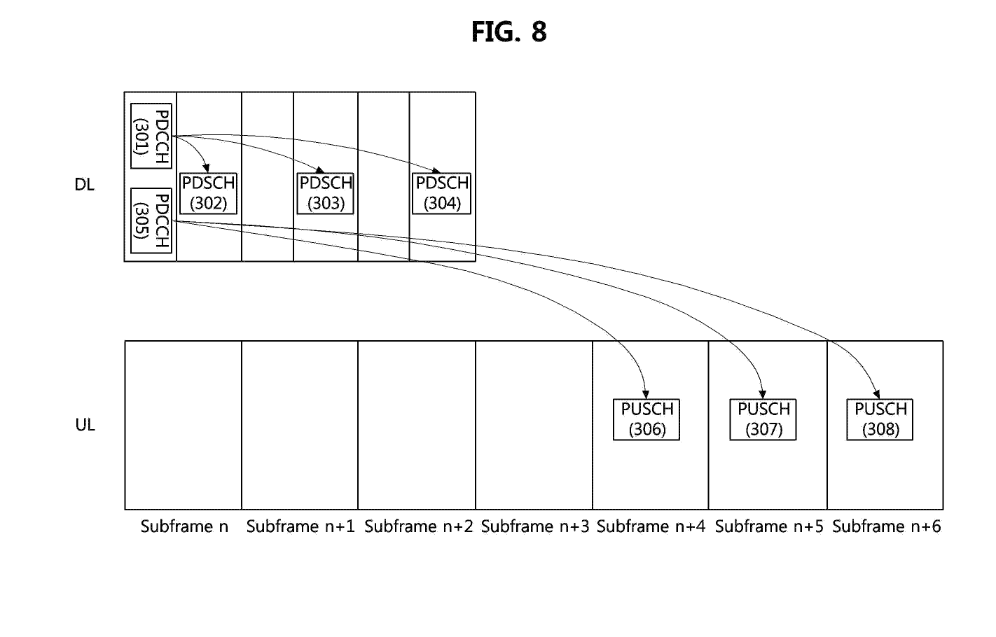

FIG. 8 is a diagram to explain a concept of multi-subframe scheduling through PDCCH according to an example embodiment of the present invention.

Referring to FIG. 8, PDCCH 301 may be used for transferring control information for two or more PDSCHs 302, 303, and 304 located in two or more subframes. The two or more PDSCHs may include PDSCH 302 located in a same subframe with the PDCCH 301 and PDSCHs 303 and 304 located in a subframe different from the subframe of PDCCH 301. In this case, control information for two or more PDSCHs 302, 303, and 304 may be configured in a control channel of the same subframe.

Also, PDCCH 305 may be used for transferring control information for two or more PUSCHs 306, 307, and 308 located in two or more subframes. The two or more PUSCHs may include PUSCH 306 located in an uplink subframe related to the downlink subframe in which PDCCH 305 exists (e.g., the subframe (n+4) in case of FDD, and the subframe (n+k) in case of TDD), and PUSCHs 307 and 308 located in an uplink subframe which is not related to the downlink subframe in which PDCCH 305 exists. In this case, control information for two or more PUSCHs 306, 307, and 308 may be configured in a control channel of the same subframe.

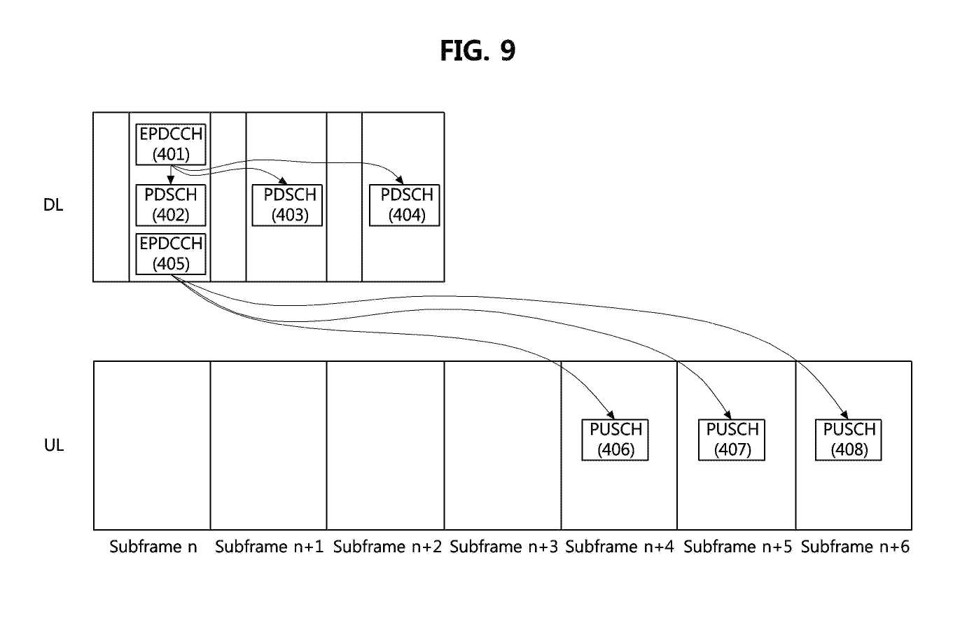

FIG. 9 is a diagram to explain a concept of multi-subframe scheduling through EPDCCH according to another example embodiment of the present invention.

Referring to FIG. 9, EPDCCH 401 may be used for transferring control information for two or more PDSCHs 402, 403, and 404 located in two or more subframes. The two or more PDSCHs may include PDSCH 402 located in a same subframe with the EPDCCH 401 and PDSCHs 403 and 404 located in a subframe different from the subframe of EPDCCH 401. In this case, control information for two or more PDSCHs 402, 403, and 404 may be configured in a control channel of the same subframe.

Also, EPDCCH 405 may be used for transferring control information for two or more PUSCHs 406, 407, and 408 located in two or more subframes. The two or more PUSCHs may include PUSCH 406 located in uplink subframes related to the downlink subframe in which EPDCCH 305 exists (e.g., the subframe (n+4) in case of FDD, and the subframe (n+k) in case of TDD), and PUSCHs 407 and 408 located in an uplink subframe which is not related to the downlink subframe in which EPDCCH 405 exists. In this case, control information for two or more PUSCHs 406, 407, and 408 may be configured in a control channel of the same subframe.

On the other hand, the terminal 10 and the base station 20 may communicate with each other by using a plurality of component carriers (CCs). That is, the terminal 10 and the base station 20 may communicate by using a primary cell (PCell) and at least one secondary cell (SCell). In this case, control information of a component carrier may be transferred through PDCCH or EPDCCH of another component carrier, and this type of scheduling may be referred to as ‘cross-carrier scheduling’.

Also, for the small cell scenarios in FIG. 4 and FIG. 5, the terminal may separate frequencies of the macro cell and the small cell. That is, a component carrier used for the terminal to communicate with the macro cell may be different from a component carrier used for the terminal to communicate with the small cell. For example, the terminal and the macro cell may communicate using PCell, and the terminal and the small cell may communicate using SCell. In this case, downlink control information is received only from the macro cell via PCell, and the small cell may be used only for data transmission as a SCell. Here, in case that the small cell is used only for data transmission as a SCell, a control region may not be configured in the SCell.

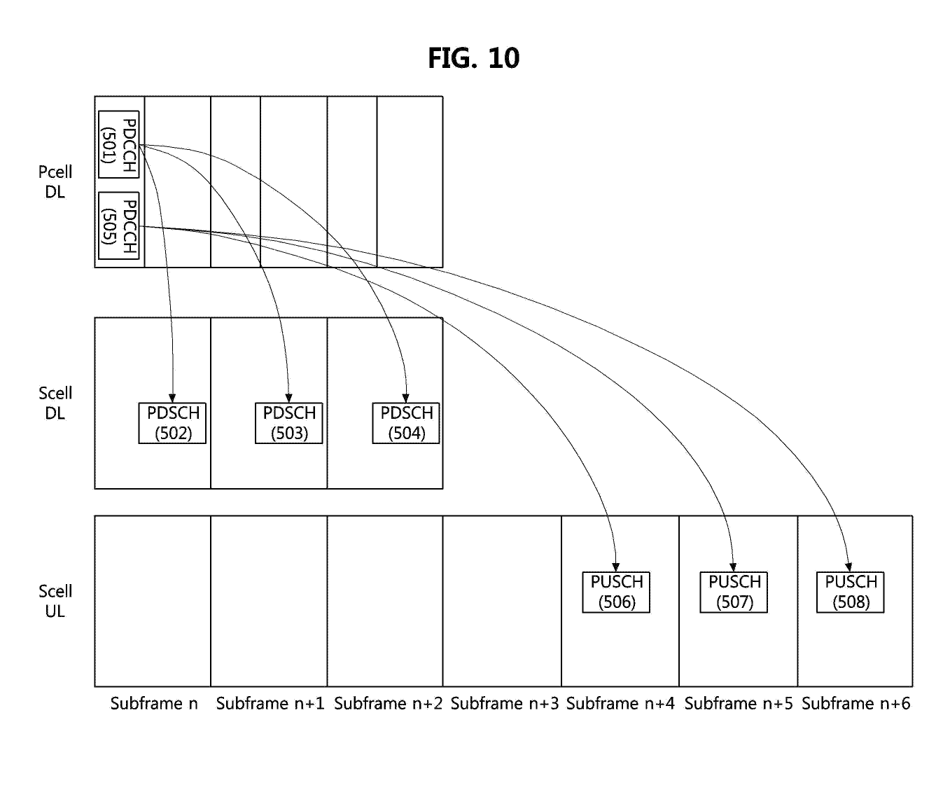

FIG. 10 is a diagram to explain a concept of cross-carrier/multi-subframe scheduling according to still another example embodiment of the present invention.

Referring to FIG. 10, PDCCH 501 of PCell may be used for transferring control information for two or more PDSCHs 502, 503, and 504 located in two or more subframes of SCell. The two or more PDSCHs may include PDSCH 502 located in a same subframe with the PDCCH 501 and PDSCHs 503 and 504 located in a subframe different from the subframe of PDCCH 501. In this case, control information for two or more PDSCHs 502, 503, and 504 may be configured in a control channel of the same subframe.

Also, PDCCH 505 of PCell may be used for transferring control information for two or more PUSCHs 506, 507, and 508 located in two or more subframes. The two or more PUSCHs may include PUSCH 506 located in uplink subframes related to the downlink subframe in which PDCCH 505 exists (e.g., the subframe (n+4) in case of FDD, and the subframe (n+k) in case of TDD), and PUSCHs 507 and 508 located in an uplink subframe which is not related to the downlink subframe in which PDCCH 505 exists. In this case, control information for two or more PUSCHs 506, 507, and 508 may be configured in a control channel of the same subframe.

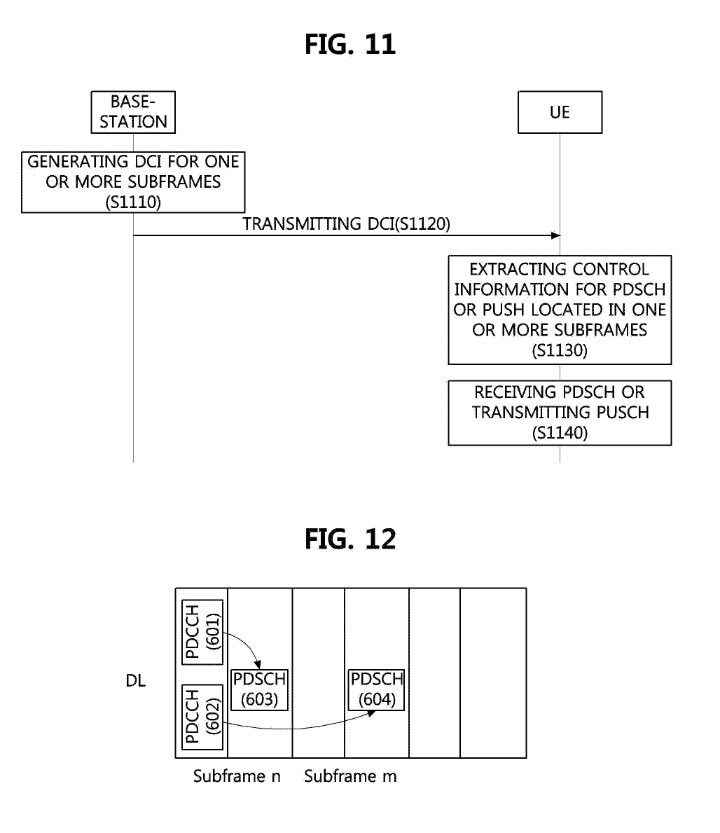

In the example embodiment of FIG. 11, the macro cell may transmit control information to the terminal by using PDCCHs 501 and 505 of PCell, and the small cell may transmit data to the terminal by using PDSCHs 502, 503, and 504 of SCell and receive data from the terminal by using PUSCHs 506, 507, and 508.

In the example of FIG. 10, the SCell may have only a data region without being configured to have a control region for control channels.

In the example of FIG. 10, although it is illustrated as control information transferred via PCell is only for data channels (PDSCH or PUSCH) of SCell, the present invention is not limited to the example. For example, control information transferred via a SCell may be for a data channel of another SCell.

Although control information is transferred by using PDCCH in FIG. 10, this is only an example. That is, control information may also be transferred by using EPDCCH.

In the example embodiments of the present invention, downlink control information (DCI) transferred through PDCCH or EPDCCH may include a field indicating one or more subframes.

For example, the field indicating one or more subframes may have a bitmap form which can represent at least one subframe to which the downlink control information is applied among a plurality of subframes. Alternatively, the field indicating one or more subframes may have a value representing the number of subframes to which the downlink control information is applied. Alternatively, a plurality of patterns on subframes to which the downlink control information is applied may be determined according to a predetermined rule, the field indicating one or more subframes may have a value indicating one of the plurality of patterns. In this case, the macro cell may transmit downlink control information including the field indicating one or more subframes to the terminal, and the small cell may transmit data to the terminal through one or more subframes determined according to the field indicating the one or more subframes.

Also, the plurality of patterns on subframes to which downlink control information is applied may be determined via upper layer signaling (e.g., Radio Resource Control (RRC)), and the field indicating one or more subframes may be a value indicating one of the plurality of patterns. In this case, the macro cell may transmit information on the plurality of patterns to the terminal via RRC signaling, and transmit downlink control information including the field indicating one of the plurality of patterns. Accordingly, the small cell may transmit data to the terminal through one or more subframes determined according to the indicated pattern.

In case that cross-carrier/multi-subframe scheduling is considered, the downlink control information may include a field indicating a component carrier (e.g., a channel indication field (CIF)) and a filed indicating one or more subframes.

Alternatively, a part of the filed indicating a component carrier may be used for indicating a subframe (i.e., used in case that multi-subframe scheduling is not used) and a component carrier, and another part of the field may be used for indicating a plurality of subframes and a component carrier.

For example, CIF comprising 3 bits may indicate at most 8 cases. Thus, in case that 5 cases are used for indicating a component carrier, other 3 cases may be used for multi-subframe scheduling. The following table 1 represents an example in which 3 bits CIF is used for scheduling of component carrier and multi-subframes.

TABLE 1

| CIF | CC or multi-subframe scheduling |
|---|---|
| 000 | PCell, 1 subframe |
| 001 | SCell1, 1 subframe |
| 010 | SCell2, 1 subframe |
| 011 | SCell3, 1 subframe |
| 100 | SCell4, 1 subframe |
| 101 | PCell, 2 subframes |
| 110 | SCell1, 2 subframes |
| 111 | SCell2, 2 subframe |

Referring to the table 1, values 000-100 of CIF may indicate a single CC and a single subframe, and values 101-111 of CIF may indicate a single CC and multiple subframes.

For another example, CIF comprising 4 bits may indicate at most 16 cases. Thus, in case that 5 cases are used for indicating a component carrier, other 11 cases may be used for multi-subframe scheduling.

TABLE 2

| CIF | CC or multi-subframe scheduling |
|---|---|
| 0000 | PCell, 1 subframe |
| 0001 | SCell1, 1 subframe |
| 0010 | SCell2, 1 subframe |
| 0011 | SCell3, 1 subframe |
| 0100 | SCell4, 1 subframe |
| 0101 | PCell, 2 subframes |
| 0110 | PCell, 3 subframes |
| 0111 | SCell1, 2 subframes |
| 1000 | SCell1, 3 subframes |
| 1001 | SCell2, 2 subframes |
| 1010 | SCell2, 3 subframes |
| 1011 | SCell3, 2 subframes |
| 1100 | SCell3, 3 subframes |
| 1101 | SCell4, 2 subframes |
| 1110 | SCell4, 3 subframes |
| 1111 | |

Referring to the table 2, values 0000-0100 of CIF may indicate a single CC and a single subframe, and values 0101-1111 of CIF may indicate a single CC and multiple subframes.

The tables 1 and 2 are only for exemplification. CIF may be used for indicating component carrier(s) and/or multi-subframes in other ways.

In another example embodiment, the number of subframes to which downlink control information transmitted in a single subframe is applied to may be determined via upper layer signaling such as RRC in a semi-static manner. In this case, the downlink control information may be transmitted with a periodicity determined according to the number of subframes. For example, in case that a single downlink control information is determined to be applied to 3 subframes, the downlink control information may be transferred with a periodicity of 3 subframes, and the terminal may decode PDCCH or EPDCCH and extract its downlink control information with a periodicity of 3 subframes. For this, the macro cell may transfer information on cycle and offset of subframes through which downlink control information is transmitted, transmit downlink control information to the terminal via PDCCH or EPDCCH located in the subframes determined based on the cycle and offset. Accordingly, the small cell may transmit data to the terminal with the periodicity.

FIG. 11 is a flowchart illustrating a method of transmitting/receiving control information according to an example embodiment of the present invention.

Referring to FIG. 11, the base station may generate downlink control information (DCI) for one or more subframes (S1110).

In an embodiment, the DCI may include a field indicating one or more subframes.

For example, the field indicating one or more subframes may have a bitmap form which can represent at least one subframe to which the downlink control information is applied among a plurality of subframes. Alternatively, the field indicating one or more subframes may have a value representing the number of subframes to which the downlink control information is applied. Alternatively, a plurality of patterns on subframes to which the downlink control information is applied may be determined according to a predetermined rule, the field indicating one or more subframes may have a value indicating one of the plurality of patterns. In this case, the macro cell may transmit downlink control information including the field indicating one or more subframes to the terminal, and the small cell may transmit data to the terminal through one or more subframes determined according to the field indicating the one or more subframes.

Also, the plurality of patterns on subframes to which downlink control information is applied may be determined via upper layer signaling (e.g., Radio Resource Control (RRC)), and the field indicating one or more subframes may be a value indicating one of the plurality of patterns. In this case, the macro cell may transmit information on the plurality of patterns to the terminal via RRC signaling, and transmit downlink control information including the field indicating one of the plurality of patterns. Accordingly, the small cell may transmit data to the terminal through one or more subframes determined according to the indicated pattern.

In case that cross-carrier/multi-subframe scheduling is considered, the downlink control information may include a field indicating a component carrier (e.g., a channel indication field (CIF)) and a filed indicating one or more subframes.

Alternatively, a part of the filed indicating a component carrier may be used for indicating a subframe (i.e., used in case that multi-subframe scheduling is not used) and a component carrier, and another part of the field may be used for indicating a plurality of subframes and a component carrier.

In another example embodiment, the number of subframes to which downlink control information transmitted in a single subframe is applied to may be determined via upper layer signaling such as RRC in a semi-static manner. In this case, the downlink control information may be transmitted with a periodicity determined according to the number of subframes. For example, in case that a single downlink control information is determined to be applied to 3 subframes, the downlink control information may be transferred with a periodicity of 3 subframes, and the terminal may decode PDCCH or EPDCCH and extract its downlink control information with a periodicity of 3 subframes. For this, the macro cell may transfer information on cycle and offset of subframes through which downlink control information is transmitted, transmit downlink control information to the terminal via PDCCH or EPDCCH located in the subframes determined based on the cycle and offset. Accordingly, the small cell may transmit data to the terminal with the periodicity.

Referring to FIG. 11, the base station may transmit the generated DCI to the terminal (S1120), the terminal receiving the DCI may extract control information of PDSCH or PUSCH located in one or more subframes (S1130). Accordingly, the terminal may receive downlink data via PDSCH, or transmit uplink data via PUSCH by using the extracted control information.

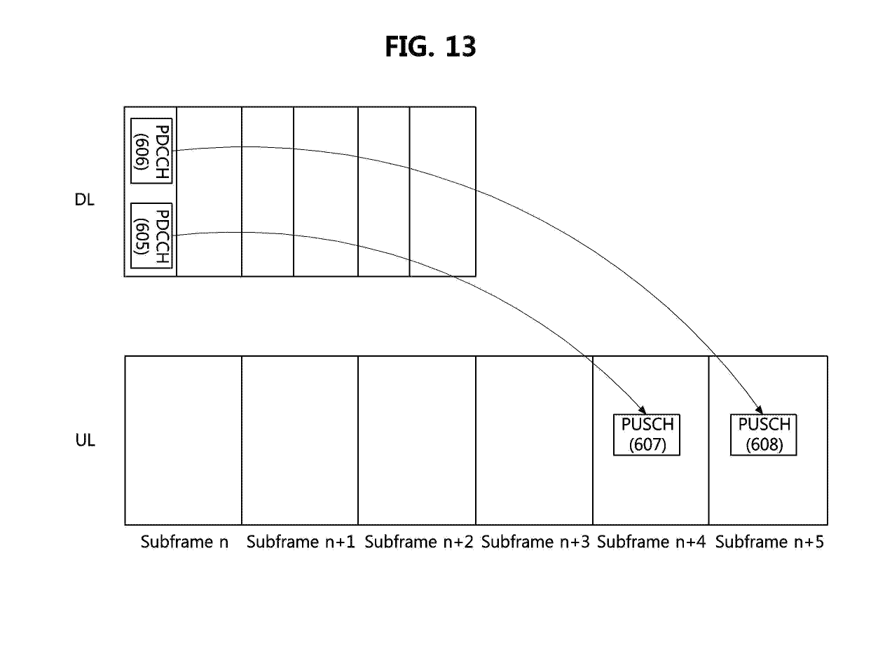

FIG. 12 and FIG. 13 are diagrams to explain a cross-subframe scheduling through PDCCH according to still another example embodiment of the present invention. FIG. 12 is for a downlink cross-subframe scheduling, and FIG. 13 is for an uplink cross-subframe scheduling.

Referring to FIG. 12, PDCCH 601 of a subframe n may be used for transferring control information for PDSCH 603 located in the same subframe n, and PDCCH 602 may be used for transferring control information for PDSCH 604 located in a different subframe m.

Referring to FIG. 13, PDCCH 605 of a subframe n may be used for transferring control information for PUSCH 607 located in an uplink subframe related to the downlink subframe n (e.g., the subframe (n+4) in case of FDD, and the subframe (n+k) in case of TDD). On the contrary, PDCCH 606 may be used for transferring control information for PUSCH 608 located in an uplink subframe which is not related to the downlink subframe n.

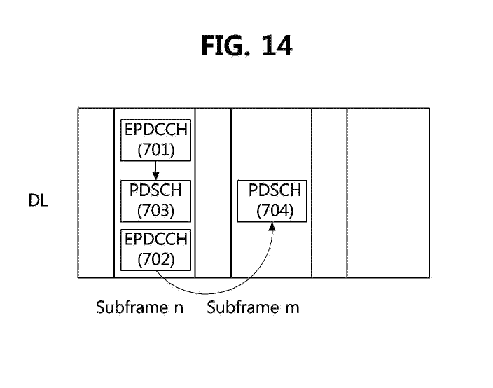

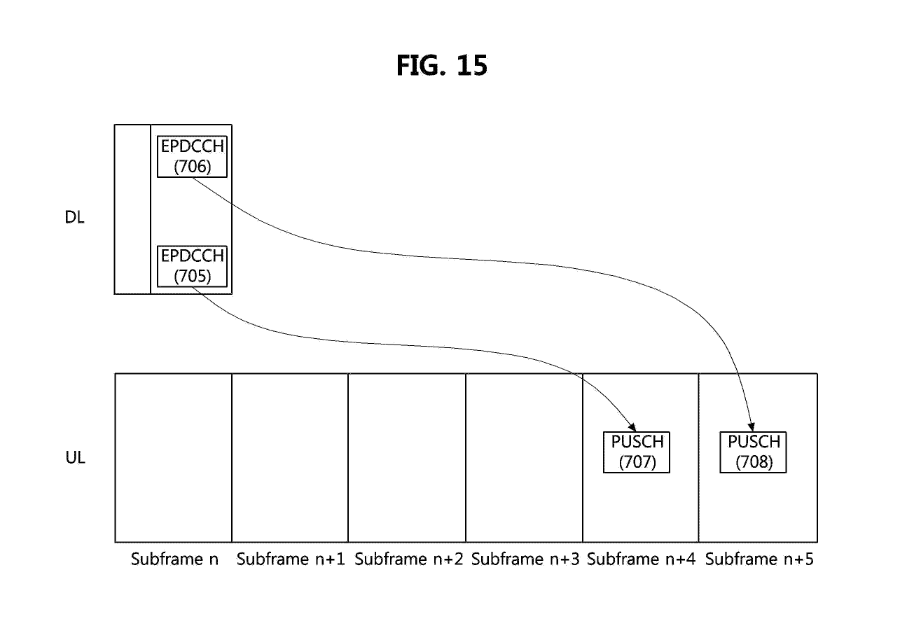

FIG. 14 and FIG. 15 are diagrams to explain a cross-subframe scheduling through PDCCH according to still another example embodiment of the present invention. FIG. 14 is for a downlink cross-subframe scheduling, and FIG. 15 is for an uplink cross-subframe scheduling.

Referring to FIG. 14, EPDCCH 701 of a subframe n may be used for transferring control information for PDSCH 703 located in the same subframe n, and EPDCCH 702 may be used for transferring control information for PDSCH 704 located in a different subframe m.

Referring to FIG. 15, EPDCCH 705 of a subframe n may be used for transferring control information for PUSCH 707 located in an uplink subframe related to the downlink subframe n (e.g., the subframe (n+4) in case of FDD, and the subframe (n+k) in case of TDD). On the contrary, EPDCCH 706 may be used for transferring control information for PUSCH 708 located in an uplink subframe which is not related to the downlink subframe n.

On the other hand, the terminal 10 and the base station 20 may communicate with each other by using a plurality of component carriers (CCs). That is, the terminal 10 and the base station 20 may communicate by using a primary cell (PCell) and at least one secondary cell (SCell). In this case, control information of a component carrier may be transferred through PDCCH or EPDCCH of another component carrier, and this type of scheduling may be referred to as ‘cross-carrier scheduling’.

Also, for the small cell scenarios in FIG. 4 and FIG. 5, the terminal may separate frequencies of the macro cell and the small cell. That is, a component carrier used for the terminal to communicate with the macro cell may be different from a component carrier used for the terminal to communicate with the small cell. For example, the terminal and the macro cell may communicate using PCell, and the terminal and the small cell may communicate using SCell. In this case, downlink control information is received only from the macro cell via PCell, and the small cell may be used only for data transmission as a SCell. Here, in case that the small cell is used only for data transmission as a SCell, a control region may not be configured in the SCell.

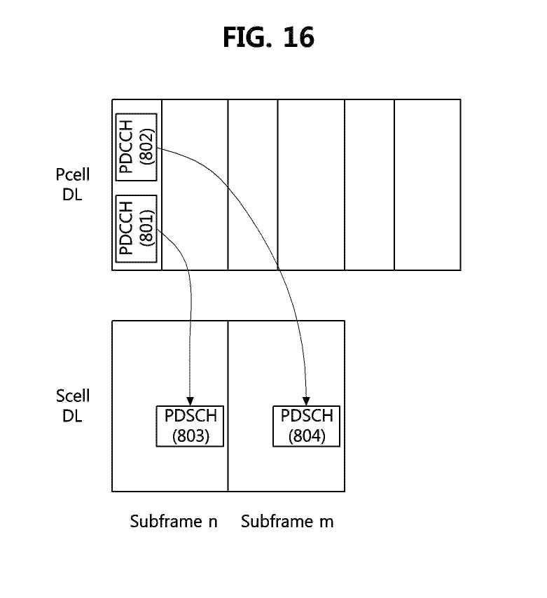

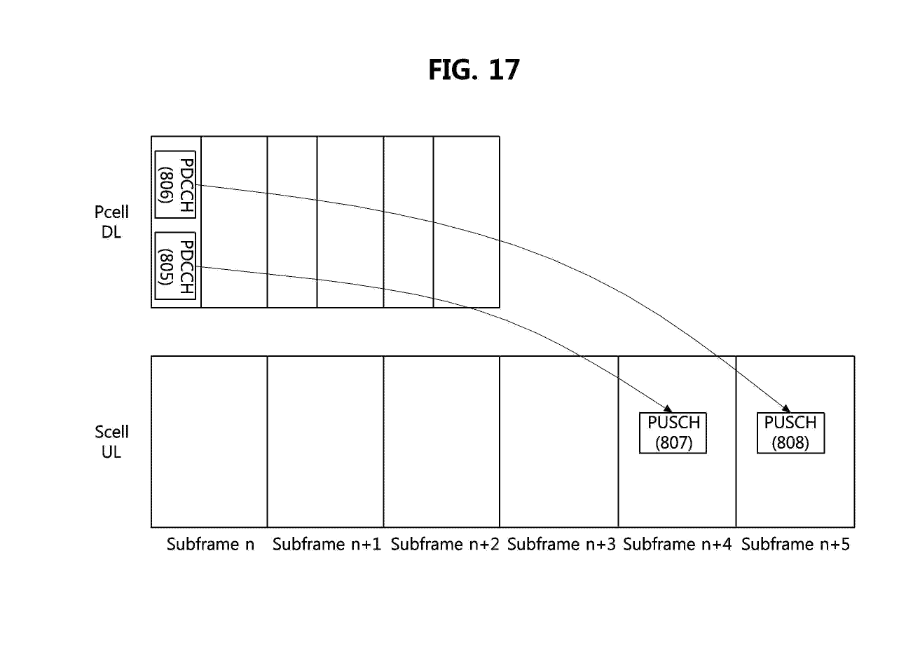

FIG. 16 and FIG. 17 are diagrams to explain a cross-carrier/cross-subframe scheduling concept according to still another example embodiment of the present invention. FIG. 16 is for a downlink cross-carrier/cross-subframe scheduling, and FIG. 17 is for an uplink cross-carrier/cross-subframe scheduling.

Referring to FIG. 16, PDCCHs 801 and 802 of PCell may be used for transferring control information for PDSCHs 803 and 804 of SCell. PDCCH 801 in a subframe n of PCell may be used for transferring control information for PDSCH 803 located in the same subframe n of SCell, and PDCCH 803 in the subframe n of PCell may be used for transferring control information for PDSCH 804 located in a different subframe m of SCell.

Referring to FIG. 17, PDCCHs 805 and 806 of PCell may be used for transferring control information for PUSCHs 807 and 808 of SCell. PDCCH 805 in a subframe n of PCell may be used for transferring control information for PUSCH 807 located in an uplink subframe of SCell related to the downlink subframe n (e.g., the subframe (n+4) in case of FDD, and the subframe (n+k) in case of TDD). On the contrary, PDCCH 806 in the subframe n of PCell may be used for transferring control information for PUSCH 808 located in an uplink subframe which is not related to the downlink subframe n.

In the example embodiment of FIG. 16 and FIG. 17, the macro cell may transmit control information to the terminal by using PDCCHs 801, 802, 805, and 806 of PCell, and the small cell may transmit data to the terminal by using PDSCHs 803, and 804 of SCell and receive data from the terminal by using PUSCHs 807, and 808.

In the example of FIG. 16, the SCell may have only a data region without being configured to have a control region for control channels.

In the example of FIG. 16 and FIG. 17, although it is illustrated as control information transferred via PCell is only for data channels (PDSCH or PUSCH) of SCell, the present invention is not limited to the example. For example, control information transferred via a SCell may be for a data channel of another SCell.

Although control information is transferred by using PDCCH in FIG. 16 and FIG. 17, this is only an example. That is, control information may also be transferred by using EPDCCH.

In another example embodiment of the present invention, downlink control information (DCI) transferred through PDCCH or EPDCCH may include a field indicating a subframe.

For example, in case of control information related to PDSCH, the filed indicating a subframe may be a value indicating a difference value between a subframe of the PDCCH and a subframe of a PDSCH indicated by the PDCCH. Alternatively, in case of TDD, the field indicating a subframe may be a value indicating where the subframe of the PDSCH indicated by the PDCCH exists from the subframe of the PDCCH. In case that the PDCCH and the PDSCH exist in the same subframe, a value of the field may become ‘0’.

Meanwhile, in case of control information related to PUSCH, the field indicating a subframe may be a value of difference value between an uplink subframe related to the downlink subframe of the PDCCH (e.g., the subframe (n+4) in case of FDD, and the subframe (n+k) in case of TDD) and the subframe of the PUSCH indicated by the PDCCH. Alternatively, in case of TDD, the field indicating a subframe may be a value indicating where the subframe of the PUSCH exists from the uplink subframe related to the downlink subframe of the PDCCH. In case that the downlink subframe of PDCCH is identical to the uplink subframe of the PUSCH, a value of the field may become ‘0’.

For another example, a plurality of patterns on subframes to which the downlink control information is applied may be determined according to a predetermined rule, the field indicating one or more subframes may have a value indicating one of the plurality of patterns.

In this embodiment, the macro cell may transmit downlink control information including the field indicating one or more subframes to the terminal, and the small cell may transmit data to the terminal through one or more subframes determined according to the field indicating the one or more subframes.

Alternatively, in another embodiment, the plurality of patterns on subframes to which downlink control information is applied may be determined via upper layer signaling (e.g., Radio Resource Control (RRC)), and the field indicating one or more subframes may be a value indicating one of the plurality of patterns. In this case, the macro cell may transmit information on the plurality of patterns to the terminal via RRC signaling, and transmit downlink control information including the field indicating one of the plurality of patterns. Accordingly, the small cell may transmit data to the terminal through one or more subframes determined according to the indicated pattern.

In case that cross-carrier/cross-subframe scheduling is considered, the downlink control information may include a field indicating a component carrier (e.g., a channel indication field (CIF)) and a filed indicating a subframe.

Or, a part of the field indicating a component carrier may be used for cross-subframe scheduling.

For example, CIF comprising 3 bits may indicate at most 8 cases. Thus, when 5 cases are used for indicating a component carrier, other 3 cases may be used for cross-subframe scheduling. The following table 1 represents an example in which 3 bits CIF is used for scheduling of component carrier and cross-subframes.

TABLE 3

| CIF | CC or cross-subframe scheduling |
|---|---|
| 000 | PCell, subframe 0 |
| 001 | SCell1, subframe 0 |
| 010 | SCell2, subframe 0 |
| 011 | SCell3, subframe 0 |
| 100 | SCell4, subframe 0 |
| 101 | PCell, subframe 1 |
| 110 | SCell1, subframe 1 |
| 111 | SCell2, subframe 1 |

Referring to the table 3, values 000-100 of CIF may indicate a single CC and a subframe (subframe 0) related to the control information comprising the CIF, and values 101-111 of CIF may indicate a single CC and a subframe (subframe 1) which is not related to the control information comprising the CIF.

For another example, CIF comprising 4 bits may indicate at most 16 cases. Thus, when 5 cases are used for indicating a component carrier, other 11 cases may be used for cross-subframe scheduling.

TABLE 4

| CIF | CC or cross-subframe scheduling |
|---|---|
| 0000 | PCell, subframe 0 |
| 0001 | SCell1, subframe 0 |
| 0010 | SCell2, subframe 0 |
| 0011 | SCell3, subframe 0 |
| 0100 | SCell4, subframe 0 |
| 0101 | PCell, subframe 1 |
| 0110 | PCell, subframe 2 |
| 0111 | SCell1, subframe 1 |
| 1000 | SCell1, subframe 2 |
| 1001 | SCell2, subframe 1 |
| 1010 | SCell2, subframe 2 |
| 1011 | SCell3, subframe 1 |
| 1100 | SCell3, subframe 2 |
| 1101 | SCell4, subframe 1 |
| 1110 | SCell4, subframe 2 |
| 1111 | |

Referring to the table 4, values 0000-0100 of CIF may indicate a single CC and a subframe (subframe 0) related to the control information comprising the CIF, and values 0101-1111 of CIF may indicate a single CC and subframes (subframe 1, subframe 2) which is not related to the control information comprising the CIF.

In the tables 3 and 4, the subframe 0 is a subframe related to the control information including the CIF. In the case of control information for PDSCH, the subframe 0 may be a subframe identical to the subframe through which the control information comprising CIF is transferred. In the case of control information for PUSCH, the subframe 0 may be an uplink subframe (e.g., a subframe (n+4) in case of FDD, or a subframe (n+k) in case of TDD) related to the downlink subframe through which the control information including the CIF is transferred.

The tables 3 and 4 are only for exemplification. CIF may be used for indicating component carrier(s) and/or a cross-subframe in other ways.

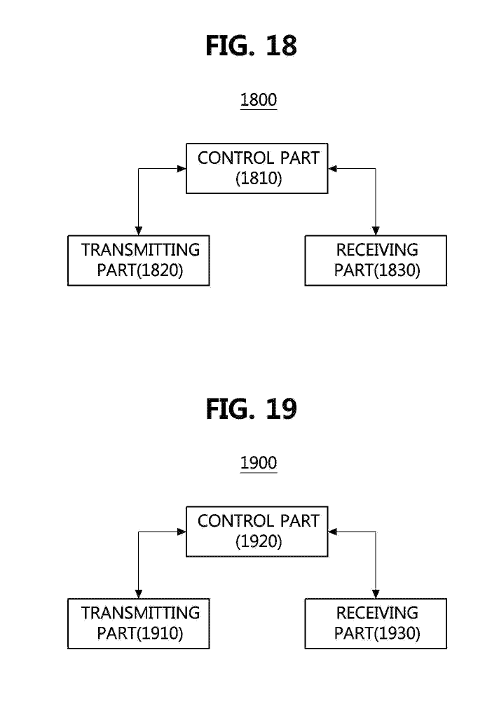

FIG. 18 is a block diagram showing a configuration of a base station according to an example embodiment of the present invention.

Referring to FIG. 18, a base station 1800 according to an example embodiment of the present invention may comprise a control part 1810, a transmitting part 1820, and a receiving part 1830.

The control part 1310 may control overall operations of the base station according to the above-described multi-subframe scheduling methods.

The transmitting part 1820 and the receiving part 1830 are used for transmitting and receiving signals, messages, and data required for performing the present invention with a terminal.

FIG. 19 is a block diagram showing a configuration of user equipment according to an example embodiment of the present invention.

Referring to FIG. 19, the user equipment 1900 according to an example embodiment of the present invention may comprise a control part 1920, a transmitting part 1930, and a receiving part 1910.

The receiving part 1910 may receive downlink control information, data, and messages from a base station through corresponding channels.

Also, the control part 1920 may control overall operations of the terminal according to the above-described multi-subframe scheduling methods.

The transmitting part 1930 may transmit downlink control information, data, and message to the base station through corresponding channels.

As described above, since the technical idea of the present invention is described by exemplary embodiments, various forms of substitutions, modifications and alterations may be made by those skilled in the art from the above description without departing from essential features of the present invention. Therefore, the embodiments disclosed in the present invention are intended to illustrate the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A base station comprising:
a control part generating downlink control information (DCI) for one or more subframes; and
a transmitting part transmitting the downlink control information through a downlink control channel.

2. The base station of claim 1, wherein the downlink control information includes a field indicating the one or more subframes.

3. The base station of claim 2, wherein the field indicating the one or more subframes includes a bitmap representing at least one subframe to which the downlink control information is applied among a plurality of subframes.

4. The base station of claim 2, wherein the field indicating the one or more subframes includes a value representing a number of subframes to which the downlink control information is applied.

5. The base station of claim 2, wherein the field indicating the one or more subframes includes a value indicating one of a plurality of patterns indicating one or more subframes, and the plurality of patterns are pre-configured or indicated from the base station to a terminal.

6. The base station of claim 2, wherein the field indicating the one or more subframes is a field indicating a component carrier and one or more subframes.

7. The base station of claim 1, wherein the number of subframes indicated by the downlink control information is indicated by the base station to a terminal via upper layer signaling.

8. The base station of claim 7, wherein the upper layer signaling includes information on cycle and offset of subframes to which the downlink control information is assigned.

9. A terminal comprising:
a receiving part receiving downlink control information (DCI) through a downlink control channel; and
a control part extracting control information of a downlink data channel positioned in one or more subframes or control information of an uplink data channel positioned in one or more subframes from the downlink control information.

10. The terminal of claim 9, wherein the downlink control information includes a field indicating the one or more subframes.

11. The terminal of claim 10, wherein the field indicating the one or more subframes includes a bitmap representing at least one subframe to which the downlink control information is applied among a plurality of subframes.

12. The terminal of claim 10, wherein the field indicating the one or more subframes includes a value representing a number of subframes to which the downlink control information is applied.

13. The terminal of claim 10, wherein the field indicating the one or more subframes includes a value indicating one of a plurality of patterns indicating one or more subframes, and the plurality of patterns are pre-configured or indicated from the base station to a terminal.

14. The terminal of claim 10, wherein the field indicating the one or more subframes is a field indicating a component carrier and one or more subframes.

15. The terminal of claim 9, wherein the number of subframes indicated by the downlink control information is indicated by the base station to a terminal via upper layer signaling.

16. The terminal of claim 15, wherein the upper layer signaling includes information on cycle and offset of subframes to which the downlink control information is assigned.

17. A base station comprising:
a control part generating downlink control information (DCI); and
a transmitting part transmitting the downlink control information through a downlink control channel,
wherein the downlink control information includes a field indicating a subframe including a data channel to which the downlink control information is applied.

18. The base station of claim 17, wherein the data channel is a downlink data channel, and the field includes a value indicating a difference value between the subframe including the downlink data channel and a subframe including the downlink control channel.

19. The base station of claim 17, wherein the data channel is a downlink data channel, and the field includes a value indicating where the subframe including the downlink data channel exists from a subframe including the downlink control channel.

20. The base station of claim 17, wherein the data channel is an uplink data channel, and the field includes a value indicating a difference value between the subframe including the uplink data channel and a subframe including the downlink control channel.

21. The base station of claim 17, wherein the data channel is an uplink data channel, and the field includes a value indicating where the subframe including the uplink data channel exists from a subframe including the downlink control channel.

22. The base station of claim 17, wherein the field includes a value indicating one of a plurality of patterns which indicate at least one subframe, and the plurality of patterns are pre-configured or indicated from the base station to a terminal.

23. The base station of claim 17, wherein the field is a field indicating a component carrier and a subframe.

24. A terminal comprising:
a receiving part receiving downlink control information (DCI) including a field indicating a subframe through a downlink control channel; and
a control part controlling a data channel of a subframe indicated by the field based on the downlink control information.

25. The method of claim 24, wherein the data channel is a downlink data channel, and the field includes a value indicating a difference value between the subframe including the downlink data channel and a subframe including the downlink control channel.

26. The method of claim 24, wherein the data channel is a downlink data channel, and the field includes a value indicating where the subframe including the downlink data channel exists from a subframe including the downlink control channel.

27. The method of claim 24, wherein the data channel is an uplink data channel, and the field includes a value indicating a difference value between the subframe including the uplink data channel and a subframe including the downlink control channel.

28. The method of claim 24, wherein the data channel is an uplink data channel, and the field includes a value indicating where the subframe including the uplink data channel exists from a subframe including the downlink control channel.

29. The method of claim 24, wherein the field includes a value indicating one of a plurality of patterns which indicate at least one subframe, and the plurality of patterns are pre-configured or indicated from the base station to a terminal.

30. The method of claim 24, wherein the field is a field indicating a component carrier and a subframe.
